(19) United States
(12) Patent Application Publication
(10) Pub. No.: US 2026/0045029 A1
(43) Pub. Date: Feb. 12, 2026

(54) GENERATING A PANORAMA BASED ON AN INPUT IMAGE USING A MACHINE LEARNING MODEL

(71) Applicant: Lemon Inc., Grand Cayman (KY)

(72) Inventors: Xiaoding Yuan, Los Angeles, CA (US); Kejie Li, Los Angeles, CA (US); Peng Wang, Los Angeles, CA (US)

(21) Appl. No.: 18/797,493

(22) Filed: Aug. 7, 2024

(51) Int. Cl. G06T 15/20; G06T 3/60

(52) U.S. Cl. CPC G06T 15/205; G06T 3/60

(57) ABSTRACT

The present disclosure describes techniques for generating a panorama based on an input image using a machine learning model. The input image with unknown camera parameters is received by the machine learning model. A first sub-model of the machine learning model estimates a homography matrix from the input image to a predefined canonical view. The homography matrix comprises three degrees of freedom and indicates pixel-level correspondences between the input image and the predefined canonical view. A second sub-model of the machine learning model generates a plurality of perspective views based on the homography matrix and a text description of an environment associated with the input image. the second sub-model of the machine learning model is configured to generate new content for extended areas while preserving existing image content. The panorama is generated based on the plurality of perspective views.

### BACKGROUND

Machine learning models are increasingly being used across a variety of industries to perform a variety of different tasks. Such tasks may include content generation. Improved techniques for utilizing machine learning models for content generation are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for generating a panorama based on an input image using a machine learning model in accordance with the present disclosure.

FIG. 2 shows an example system for generating a homography matrix in accordance with the present disclosure.

FIG. 3 shows an example system for generating a plurality of perspective views in accordance with the present disclosure.

FIG. 4 shows an example system for generating a plurality of perspective views in accordance with the present disclosure.

FIG. 5 shows an example system for generating a plurality of perspective views in accordance with the present disclosure.

FIG. 6 shows an example system for generating a panorama based on an input image using a machine learning model in accordance with the present disclosure.

FIG. 7 shows an example process for generating a panorama based on an input image using a machine learning model in accordance with the present disclosure.

FIG. 8 shows an example process for generating a panorama based on an input image using a machine learning model in accordance with the present disclosure.

FIG. 9 shows an example process for generating a panorama based on an input image using a machine learning model in accordance with the present disclosure.

FIG. 10 shows an example process for generating a panorama based on an input image using a machine learning model in accordance with the present disclosure.

FIG. 11 shows an example process for generating a panorama based on an input image using a machine learning model in accordance with the present disclosure.

FIG. 12 shows a table illustrating example evaluation results.

FIG. 13 shows a table illustrating example evaluation results.

FIG. 14A shows a table illustrating example evaluation results.

FIG. 14B shows a table illustrating example evaluation results.

FIG. 14C shows a table illustrating example evaluation results.

FIG. 15 shows an example computing device which may be used to perform any of the techniques disclosed herein.

### DETAILED DESCRIPTION OF ILLUSTRATIVE EMBODIMENTS

Unlike traditional content, 360-degree content, e.g., 360-degree images and videos, creates an immersive experience that allows viewers to feel as if they are part of the content's environment, rather than merely observing it from a fixed perspective. This immersive aspect has been significantly enhanced with the advent and proliferation of augmented reality (AR) and virtual reality (VR) devices. However, creating 360-degree content typically requires specialized equipment, such as a 360-degree camera, making such content creation a highly professional endeavor.

Alternatively, 360-degree content can be created using a technique called “outpainting.” Outpainting can be used to transform existing content into 360-degree formats. Image-based panorama outpainting is a necessary step towards video-based 360 movie creation. The advance of text-to-image diffusion models makes it possible to extrapolate an image into a 360-degree view. For example, one such text-to-image diffusion model proposes a panorama outpainting method that includes fine-tuning a pretrained latent diffusion model. However, with a limited amount of training data available, this method disrupts the prior knowledge of the pre-trained model and diminishes its generalization capabilities. Another existing text-to-image diffusion model maintains generalization by generating multi-view consistent panoramic images using a frozen pre-trained latent diffusion model. This method ensures geometric consistency through correspondence-aware attention, but it requires the input image to have known intrinsic and rotation matrices, limiting its application to panoramas from arbitrary images. Extending panorama generation to camera-free inputs poses significant challenges and is desired.

Described herein are techniques for extending panorama generation to camera-free input images. The techniques described herein, which can be referred to as “CamFreeDiff,” involve estimating, by a first sub-model of a machine learning model, unknown camera parameters of an input image by estimating the homography transformation from the input image to a predefined canonical view. The homography establishes a correspondence between input view and each panoramic view, allowing for the enforcement of multi-view consistency via correspondence-aware attention. The homography transformation has a three degrees of freedom (3-DoF) parameterization instead of the standard eight degrees of freedom (8-DoF) way often found in the context of panorama outpainting. The first sub-model is integrated with a second sub-model (e.g., a multi-view diffusion model) in a fully differentiable manner. By doing so, the mechanism can effectively mitigate the errors introduced by the homography estimation process. The machine learning model described herein may be fine-tuned on a high-quality dataset from a pre-trained stable diffusion inpainting model.

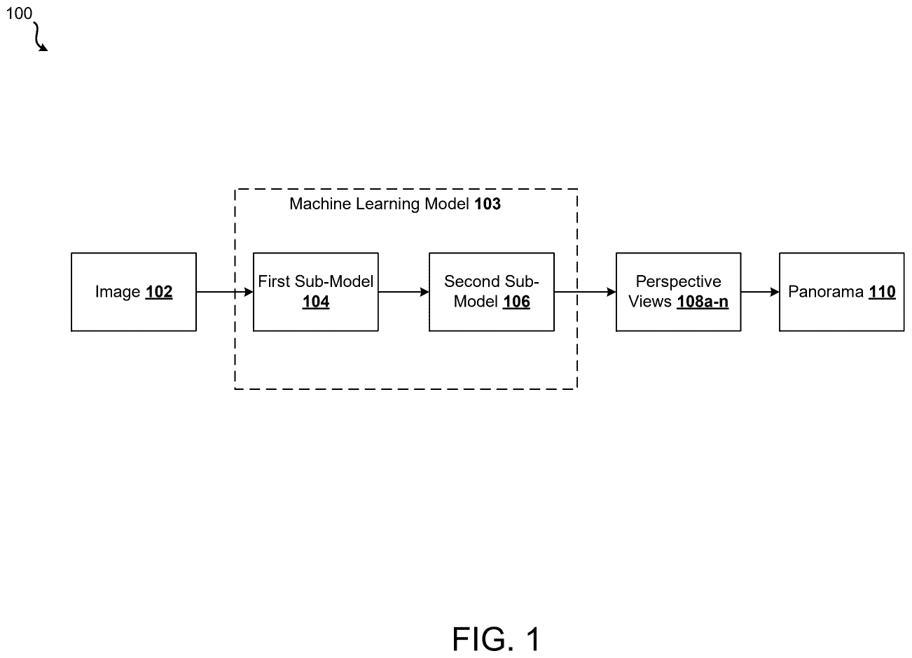

FIG. 1 shows an example system 100 for generating a panorama based on an input image using a machine learning model. The system 100 can include a machine learning model 103. The machine learning model 103 can include a first sub-model 104 and a second sub-model 106. The machine learning model 103 can be configured to generate a 360-degree panorama based on a single input image that has unknown camera parameters.

An image 102 can be input into or received by the first sub-model 104 of the machine learning model 103. The camera parameters of the image 102 can be unknown. The first sub-model 104 can be configured to estimate a homography matrix based on the image 102. The first sub-model 104 can estimate a homography matrix that can be utilized to transform the input image 102 to a predefined canonical view. The predefined canonical view may correspond to a perspective view with an absolute rotation angle of zero. The homography matrix can indicate pixel-level correspondences between the input image 102 and the predefined canonical view. The homography matrix can include three degrees of freedom (3-DoF). The 3-DoF of the homography matrix can include a camera field of view, a camera rotation around an x-axis, and a camera rotation around a z-axis.

The second sub-model 106 can generate a plurality of perspective views 108a-n based on the homography matrix. The second sub-model 106 can generate the plurality of perspective views 108a-n further based on a text description of an environment associated with the input image 102. The second sub-model 106 can be configured to generate new content for extended areas while preserving existing content in the input image. For example, the second sub-model 106 can be configured generate new content in the environment that are not shown in the input image 102, such as content for areas that surround the view shown in the input image 102, while preserving the content shown in the input image 102.

In some embodiments, the second sub-model 106 may generate the plurality of perspective views 108a-n based on a representation of a rectification of the input image 102. The input view can be rectified by unwarping and replacing the original input image 102. The input image 102 can be rectified based on the homography matrix generated by the first sub-model 104. The rectified input image can be encoded into a latent space to generate the representation of the rectified input image. The representation of the rectified input image can be provided to (e.g., input to) the second sub-model 106. The second sub-model 106 can generate the plurality of perspective views 108a-n based on the input representation of the rectified input image. A panorama 110, such as a panoramic image or video, can be generated based on the plurality of perspective views 108a-n.

In other embodiments, the second sub-model 106 may generate the plurality of perspective views 108a-n based on a rectified representation of the input image 102. The input image 102 can be encoded into a latent space. A representation of the input image 102 in the latent space can be rectified based on the homography matrix. The rectified representation can be provided to (e.g., input to) to the second sub-model 106. The second sub-model 106 can generate the plurality of perspective views 108a-n based on the rectified representation of the input image. A panorama 110, such as a panoramic image or video, can be generated based on the plurality of perspective views 108a-n.

In further embodiments, the second sub-model 106 may generate the plurality of perspective views 108a-n based on point-level correspondences from the input image to target canonical views. Point-level correspondences can be generated based on the homography matrix H. The point-level correspondences can be provided to the second sub-model 106. The second sub-model 106 can include a conditional branch associated with the input image. The second sub-model 106 may further include a plurality of generation branches. The plurality of generation branches are associated with the plurality of perspective views 108a-n. One of the plurality of generation branches can correspond to a perspective view with an absolute rotation angle of zero. Point-level information can be aggregated from the input image to the plurality of perspective views 108a-n by implementing correspondence-aware attention (CAA). CAA can be implemented not only among the plurality of generation branches, but also between the conditional branch and the plurality of generation branches, which effectively reduces inaccuracies associated with homography estimation.

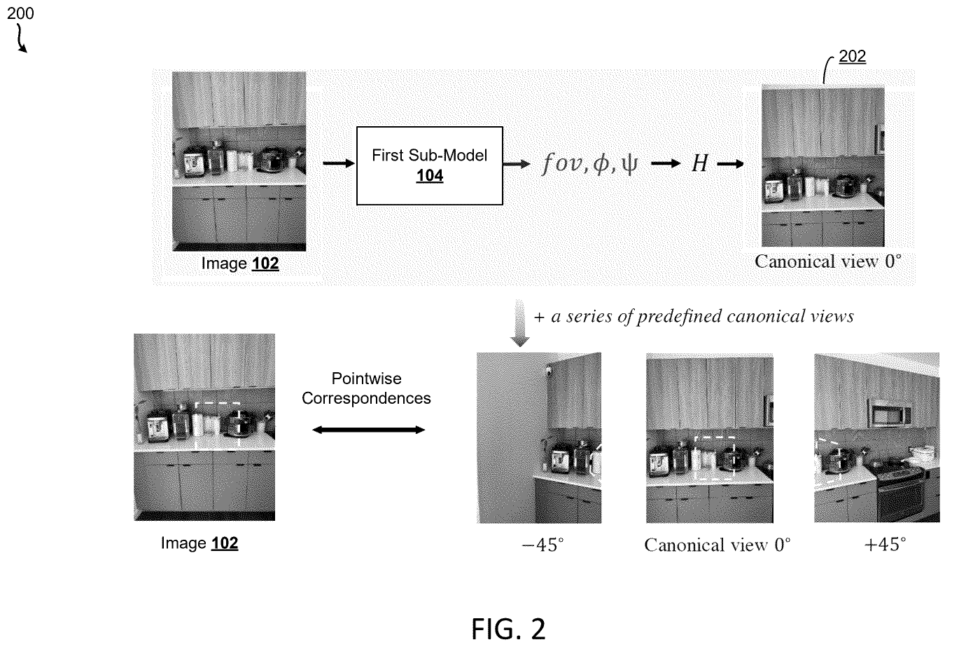

FIG. 2 shows an example system 200 for generating a homography matrix H and pointwise correspondences. The first sub-model 104 of the machine learning model 103 can predict the camera parameters of the input image by estimating the homography transformation (e.g., homography matrix H) from the input image 102 to a predefined canonical perspective view 202. For example, the first sub-model 104 can estimate the homography matrix H from the unknown input view of the input image 102 to the predefined canonical view 202. The predicted homography matrix H can provide correspondences between the input view and multiple target perspective views. Correspondence-aware attention can be used to enforce geometry consistency for the final panorama generation.

The homography H can be expressed as

$$H = {K}_{2} {RK}_{1}^{- 1} ,$$

where K₂ and K₁ are the camera intrinsics for the predefined canonical perspective view 202 and the input image 102 respectively, and R is a predicted rotation. Some variables are constant by default for common cameras. Specifically, the intrinsic matrix of a canonical view K₂ can be defined as:

$$[ \begin{matrix}{f}_{x} & γ & {c}_{x} \\ 0 & {f}_{y} & {c}_{y} \\ 0 & 0 & 1\end{matrix} ] = [ \begin{matrix}256 & 0 & 255.5 \\ 0 & 256 & 255.5 \\ 0 & 0 & 1\end{matrix} ] .$$

It can be assumed that the intrinsic of the input image 102 satisfies the pinhole camera. Thus for K₁, in accord with the canonical view intrinsic, the axis skew coefficient γ for input view also defaults to 0 and the principal point offsets (cₓ, c_{y}) default to the center of the image (w/2, h/2).

In embodiments, the homography matrix H has 3-DoF. The 3-DoF include a camera field of view (f), a camera rotation around the x-axis (ϕ), and a camera rotation around the z-axis (ψ). Particularly, under the condition of a single input image, predicting the absolute rotation around the y-axis (θ) is considered meaningless since the input view can be mapped to any standard canonical view of a 360-degree panorama with 0≤θ≤360°. As such, the model that predicts the homography matrix H from the input image I∈R^{H×W×3} (e.g., the input image 102) to the predefined canonical view 202 can be formulated as M(I)→(f, ϕ, ψ). The input image's camera intrinsic K₁ can be determined based on the predicted f. Along with known target perspective camera intrinsic and the predicted rotation R from (ϕ, ψ, θ=0), the homography transformation H can be recovered from the predictions (f, ϕ, ψ).

The first sub-model 104 of the machine learning model 103 can be a Multi-Layer Perceptron (MLP) classifier with three hidden layers built upon a general image encoder. The homography estimator can be a U-Net encoder pre-trained by a stable diffusion model for image generation, but with weights frozen for efficiency. Only the MLP classifier (not the image encoder) can be optimized to learn a homography estimator. Feature dimensions for each hidden layer in the MLP can be set to 5120, 2560 and 1280. SiLU can be used as the activation functions in the MLP block. Cross-entropy loss can be applied as learning objectives to fov, ϕ and ψ, respectively.

The homography matrix H can provide pixel-level correspondences between the input image 102 and the predefined canonical view 202. Consider the homography transformation from view Iₐ to view I_{b} as H_{a,b}. The projection from a point at location pₐ=(uₐ, vₐ) in view Iₐ and its corresponding point at location p_{b}=(u_{b}, v_{b}) in view I_{b} can be formulated as:

$$[ \begin{matrix}{u}_{b} \\ {v}_{b} \\ 1\end{matrix} ] = {H}_{a , b} [ \begin{matrix}{u}_{a} \\ {v}_{a} \\ 1\end{matrix} ] .$$

With the homography matrix from the input view to the predefined canonical view, point-wise correspondences from the input image can be aggregated to all target canonical views through correspondence-aware attention. Based on the estimated correspondences, 360-degree panoramic images can be generated.

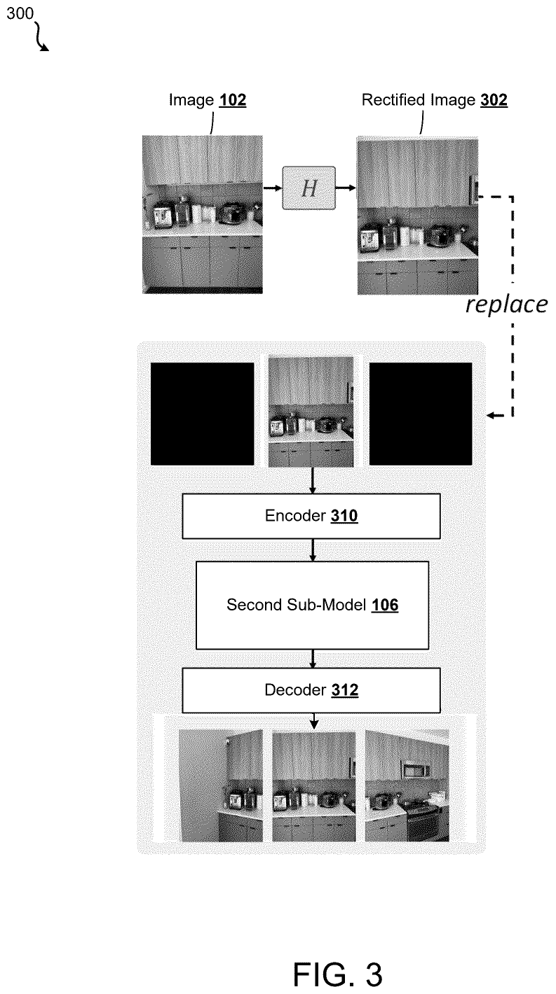

In some embodiments, the second sub-model 106 may generate the plurality of perspective views 108a-n based on a representation of a rectified input image. FIG. 3 shows an example system 300 for generating the plurality of perspective views 108a-n based on a representation of a rectification of the input image 102. Initially, the input image 102 can be transformed to a canonical view utilizing the estimated pixel-level correspondences. The input view of the input image 102 can be rectified by unwarping and replacing the original input image 102 with a rectified image 302. The rectified image 302 can be generated based on the homography matrix H. The rectified image 302 can be encoded by an encoder 310 into a latent space to generate a representation of the rectified image 302.

The representation of the rectified image 302 can be provided to the second sub-model 106. The second sub-model 106 can generate a representation of each of the plurality of perspective views 108a-n based on the representation of the rectified image 302. For example, the second sub-model 106 can include eight branches (e.g., eight diffusion branches with the same weight copy) and the plurality of perspective views 108a-n can include eight perspective views. Each of the eight diffusion branches can be configured to generate a representation of one of the plurality of perspective views 108a-n. The decoder 312 can decode the representations of the plurality of perspective views 108a-n to generate the plurality of perspective views 108a-n. A panorama, such as a 3D panoramic image or video, can be generated based on the plurality of perspective views 108a-n.

One of the eight branches of the second sub-model 106 can correspond to the canonical view (e.g., 0 degrees). The input to the branch corresponding to the canonical view can include a concatenation of noisy latent, the latent of the un-warped image, and a binary mask that identifies the areas requiring inpainting (e.g., a mask value of zero for the visible region and a mask value of one for the region that require inpainting). The inputs for the remaining seven branches can include the noisy latent, the latent of a purely white image, and a uniformly one-valued mask. The second sub-model 106 can preserve existing image content where the mask value is set to zero and can generate new content in areas where the mask value is set to one.

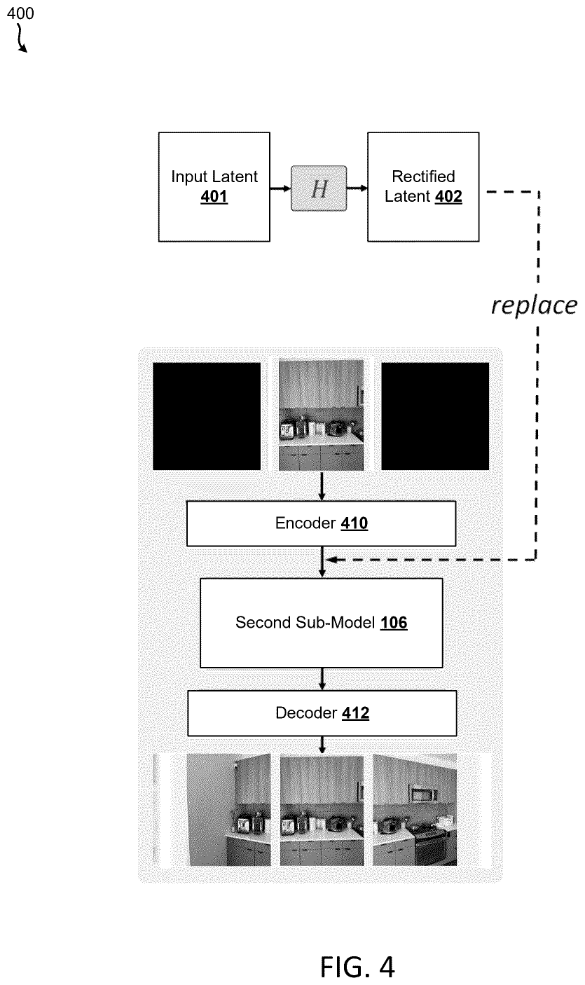

In other embodiments, the second sub-model 106 may generate the plurality of perspective views 108a-n based on a rectified representation 402 of the input image. FIG. 4 shows an example system 400 for generating the plurality of perspective views 108a-n based on a rectified representation of the input image 102. Unlike the techniques shown in FIG. 3, which initiate the process for generating the plurality of perspective views 108a-n by unwarping the input image 102 and subsequently encoding the un-warped image into a latent representation, for the techniques shown in FIG. 4, the image 102 can be first encoded into a latent space (e.g., by an encoder 410), followed by unwarping this latent representation into the canonical view (e.g., 0 degrees). For example, the input image 102 can be first encoded into a latent space. The latent representation 401 of the input image can be rectified based on the homography matrix H to obtain a rectified latent representation 402. The rectified latent representation 402 can be provided to the second sub-model 106.

The second sub-model 106 can generate a representation of each of the plurality of perspective views 108a-n based on the rectified representation 402. For example, the second sub-model 106 can include eight branches (e.g., eight diffusion branches with the same weight copy) and the plurality of perspective views 108a-n can include eight perspective views. Each of the eight diffusion branches can be configured to generate a representation of one of the plurality of perspective views 108a-n. The decoder 412 can decode the representations of the plurality of perspective views 108a-n to generate the plurality of perspective views 108a-n. A panorama, such as a 3D panoramic image or video, can be generated based on the plurality of perspective views 108a-n.

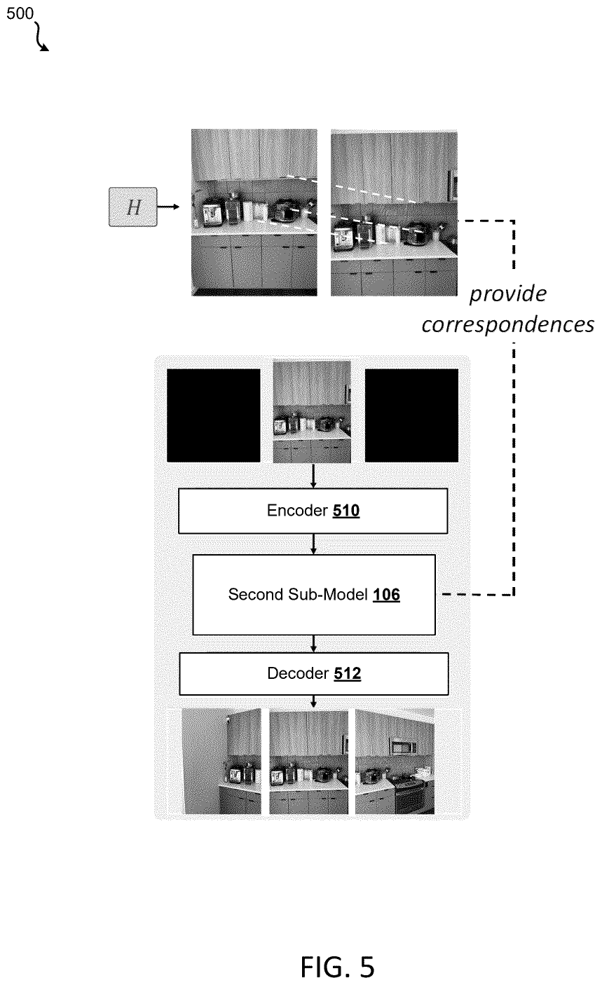

In further embodiments, the second sub-model 106 may generate a plurality of perspective views based on point-level correspondences from the input image to target views. FIG. 5 shows an example system 500 for generating the plurality of perspective views 108a-n based on point-level correspondences. The second sub-model 106 can be structured into one conditional branch and eight generation branches. Unlike the techniques described with regard to FIGS. 3-4, where the canonical view branch depends on unwarping images or latent representations, the branch of the canonical view in the system 500 is a generation branch, while the conditional branch depends on the input image 102.

The point-level correspondences can be generated based on the homography matrix H. The point-level correspondences can be provided to the second sub-model 106. The point-level information can be aggregated to the plurality of perspective views 108a-n by implementing correspondence-aware attention (CAA) to enforce geometry consistency among the plurality of perspective views. CAA can be implemented not only among the generation branches, but also between the conditional branch and the generation branches. This strategy enables to effectively reduce inaccuracies associated with homography estimation.

The second sub-model 106 can generate a representation of each of the plurality of perspective views 108a-n based on the point-level correspondences. For example, the second sub-model 106 may include eight diffusion branches. The eight diffusion branches can generate representations of eight perspective views, respectively. One of the eight diffusion branches can generate a perspective view with an absolute rotation angle of zero. The decoder 512 can decode the representations of the eight perspective views to generate the eight perspective views. A panorama, such as a 3D panoramic image or video, can be generated based on the eight perspective views.

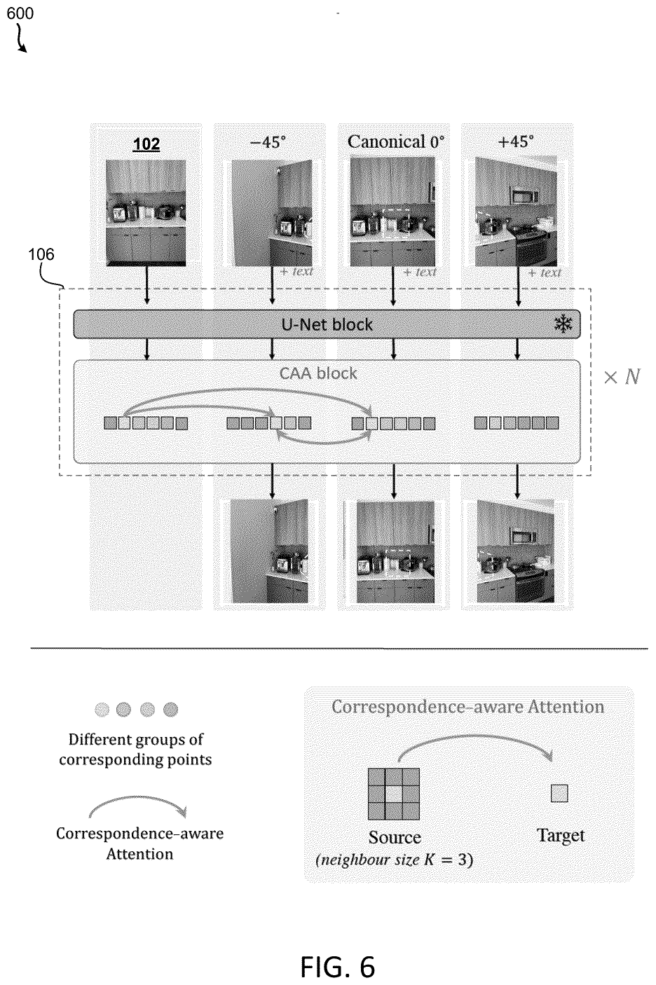

FIG. 6 shows an example system 600 for generating a plurality of perspective views based on point-level correspondences from an input image to target views. The system 600 may comprise a multi-branch diffusion denoising model including U-Net blocks and correspondence-aware attention (CAA) blocks. One CAA block may be inserted after each U-Net block. The CAA may use a size K=3 with a neighborhood of 9 points for each target pixel. For each group of corresponding points, the CAA may perform cross-attention between the source feature map and the target feature maps. While FIG. 6 only shows the cross-attention between one group of corresponding points for clear visualization, it should be appreciated that the same process is applied to all groups of corresponding points. With the predicted homography matrix from the input view (e.g., input image 102) to a predefined canonical view (e.g., a view with an absolute rotation angle of zero), point-wise information can be aggregated from the input view to target views, e.g., a −45-degree view, a zero-degree view, and a +45-degree view. The point-wise information can be aggregated from the input view to all target views through CAA.

A panorama can be generated using the above-described techniques. For example, an image can be input into or received by the first sub-model 104 of the machine learning model 103. The camera parameters of the image can be unknown. The first sub-model 104 can be configured to estimate a homography matrix based on the image. The homography matrix that can transform the input image to a predefined canonical view. The predefined canonical view corresponds to a perspective view with an absolute rotation angle of zero. The homography matrix can indicate pixel-level correspondences between the input image 102 and the predefined canonical view. The homography matrix can include 3-DoF: a camera field of view, a camera rotation around an x-axis, and a camera rotation around a z-axis.

The second sub-model 106 can generate a plurality of perspective views based on the homography matrix. The second sub-model 106 can generate the plurality of perspective views 108a-n further based on a text description of an environment associated with the input image. The text description can be, for example, “This is a bathroom with a large mirror and a sink. It has a walk in closet with a wooden door. There is a walk in shower next to the walk in closet and a large window.” The text description can describe both what is depicted in the input image, as well as the not-pictured environment surrounding what is depicted in the input image. The second sub-model 106 can be configured to generate new content for extended areas while preserving existing image content. For example, the second sub-model 106 can be configured to generate views of the environment associated with the input image that are not shown in the input image, such as views of the walk-in closet and/or walk-in shower, while also preserving the view of the environment shown in the input image, such as the large mirror and the sink. The plurality of perspective views generated by the second sub-model 106 can be used to generate the panorama.

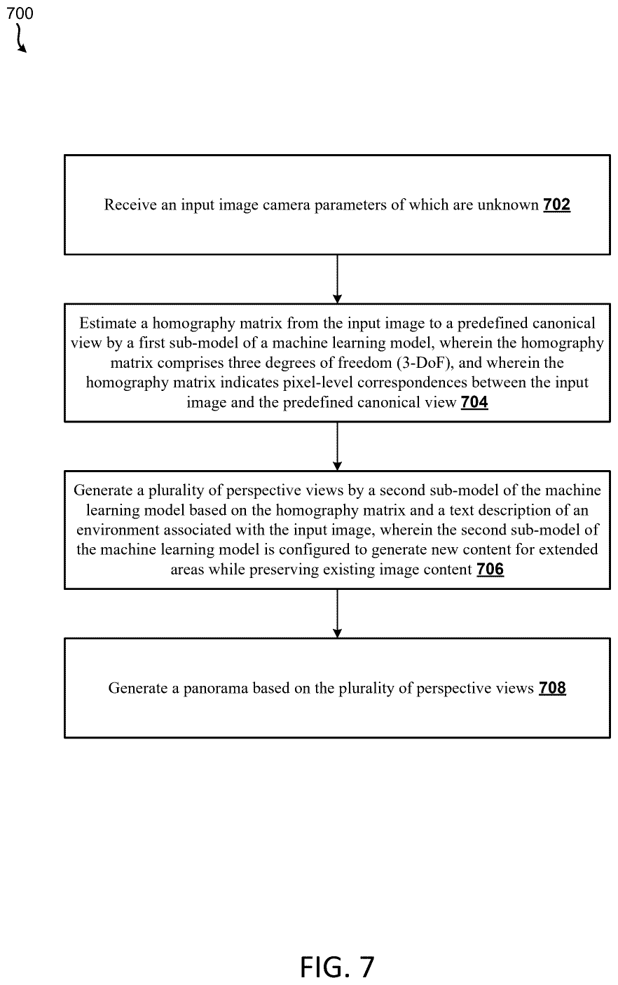

FIG. 7 illustrates an example process 700 for generating a panorama based on an input image using a machine learning model in accordance with the present disclosure. Although depicted as a sequence of operations in FIG. 7, those of ordinary skill in the art will appreciate that various embodiments may add, remove, reorder, or modify the depicted operations.

At 702, an image (e.g., image 102) can be received. The image can be received by a first sub-model (e.g., the first sub-model 104) of a machine learning model (e.g., the machine learning model 103). The camera parameters of the image can be unknown. At 704, a homography matrix can be estimated. The homography matrix can be estimated from the input image to a predefined canonical view (e.g., a view with an absolute rotation angle of zero) by the first sub-model of the machine learning model. The homography matrix can include three degrees of freedom (3-DoF). The 3-DoF of the homography matrix can include a camera field of view, a camera rotation around an x-axis, and a camera rotation around a z-axis. The homography matrix can indicate pixel-level correspondences between the input image and the predefined canonical view.

At 706, a second sub-model (e.g., the second sub-model 106) of the machine learning model can generate a plurality of perspective views (e.g., the plurality of perspective views 108a-n) based on the homography matrix. The second sub-model can generate the plurality of perspective views further based on a text description of an environment associated with the input image. The second sub-model can be configured to generate new content for extended areas while preserving existing image content. For example, the second sub-model can be configured generate views of the environment associated with the input image that are not shown in the input image, such as views of one or more areas of the environment that surround the view of the environment shown in the input image, while also preserving the view of the environment shown in the input image. At 708, a panorama can be generated. The panorama can be generated based on the plurality of perspective views.

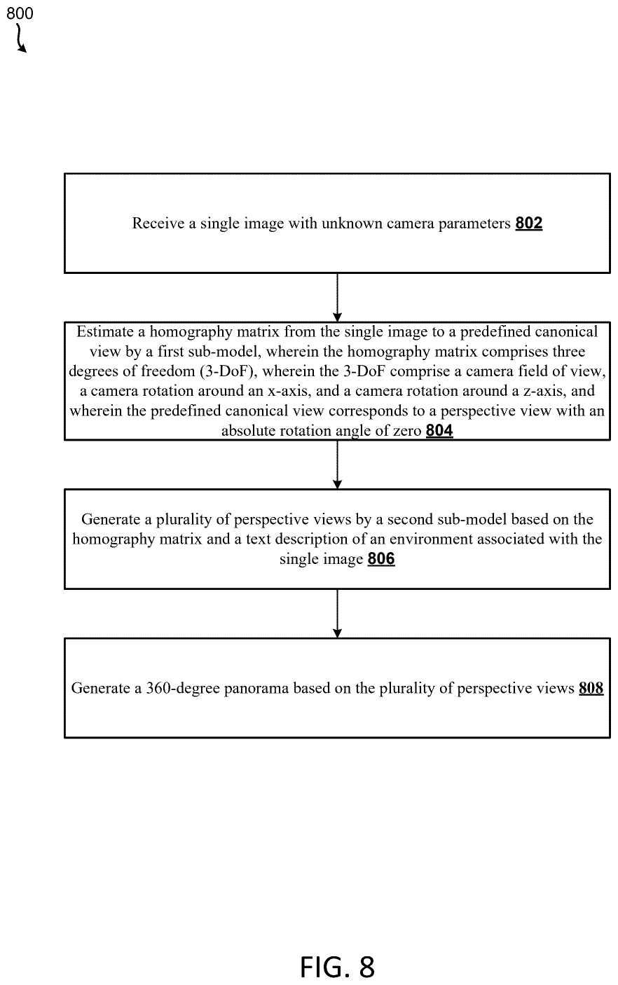

FIG. 8 shows an example process 800 for generating a panorama based on an input image using a machine learning model in accordance with the present disclosure. Although depicted as a sequence of operations in FIG. 8, those of ordinary skill in the art will appreciate that various embodiments may add, remove, reorder, or modify the depicted operations.

At 802, a single image (e.g., image 102) can be received. The single image can be received by a first sub-model (e.g., the first sub-model 104) of a machine learning model (e.g., the machine learning model 103). The single image can have unknown camera parameters. At 804, a homography matrix can be estimated. The homography matrix can be estimated from the single image to a predefined canonical view by the first sub-model of the machine learning model. The homography matrix can include three degrees of freedom (3-DoF). The 3-DoF include a camera field of view (f), a camera rotation around the x-axis (ϕ), and a camera rotation around the z-axis (ψ). The predefined canonical view can correspond to a perspective view with an absolute rotation angle of zero.

At 806, a second sub-model (e.g., the second sub-model 106) of the machine learning model can generate a plurality of perspective views (e.g., the plurality of perspective views 108a-n) based on the homography matrix. The second sub-model can generate the plurality of perspective views further based on a text description of an environment associated with the input image. At 808, a 360-degree panorama can be generated. The 360-degree panorama can be generated based on the plurality of perspective views.

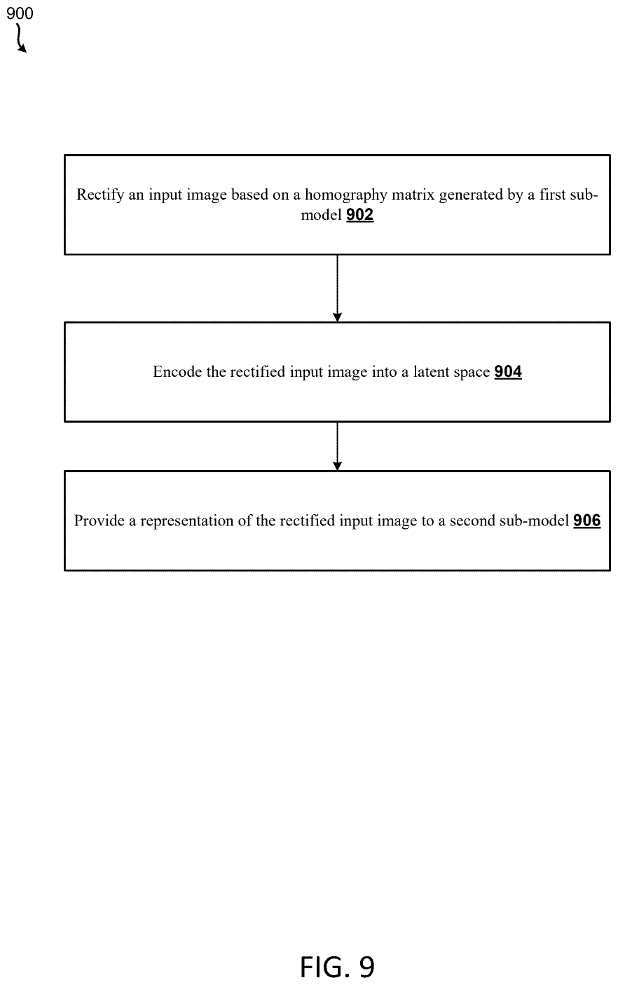

FIG. 9 shows an example process 900 for generating a panorama based on an input image using a machine learning model in accordance with the present disclosure. Although depicted as a sequence of operations in FIG. 9, those of ordinary skill in the art will appreciate that various embodiments may add, remove, reorder, or modify the depicted operations.

At 902, an input image (e.g., image 102) can be rectified. The input image can be rectified based on a homography matrix generated by a first sub-model (e.g., the first sub-model 104) of a machine learning model (e.g., the machine learning model 103). The rectified input image can be encoded into a latent space to generate a representation of the rectified input image. At 904, the rectified input image encoded into a latent space. At 906, the representation of the rectified input image can be provided to a second sub-model (e.g., the second sub-model 106) of the machine learning model. The second sub-model can generate a plurality of perspective views (e.g., the plurality of perspective views 108a-n) based on the input representation of the rectified input image. A panorama (e.g., the panorama 110), such as a panoramic image or video, can be generated based on the plurality of perspective views.

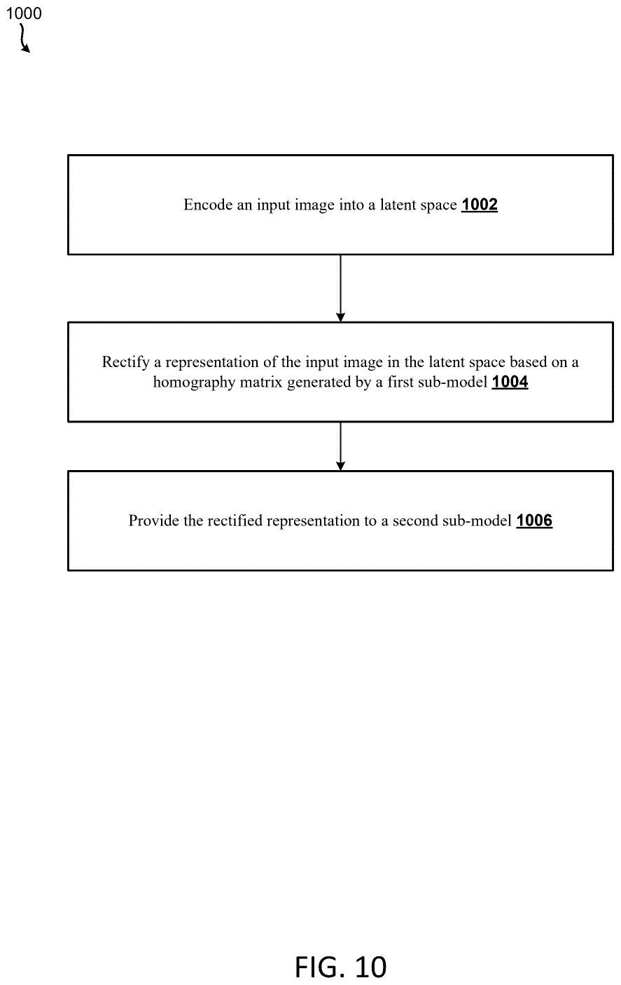

FIG. 10 shows an example process 1000 for generating a panorama based on an input image using a machine learning model in accordance with the present disclosure. Although depicted as a sequence of operations in FIG. 10, those of ordinary skill in the art will appreciate that various embodiments may add, remove, reorder, or modify the depicted operations.

At 1002, an input image (e.g., image 102) can be encoded into a latent space. At 1004, a representation of the input image in the latent space can be rectified. The representation of the input image can be rectified based on a homography matrix generated by a first sub-model (e.g., the first sub-model 104) of a machine learning model (e.g., the machine learning model 103). At 1006, the rectified representation can be provided to a second sub-model (e.g., the second sub-model 106) of the machine learning model. The second sub-model can generate a plurality of perspective views (e.g., the plurality of perspective views 108a-n) based on the rectified representation. A panorama (e.g., the panorama 110), such as a panoramic image or video, can be generated based on the plurality of perspective views.

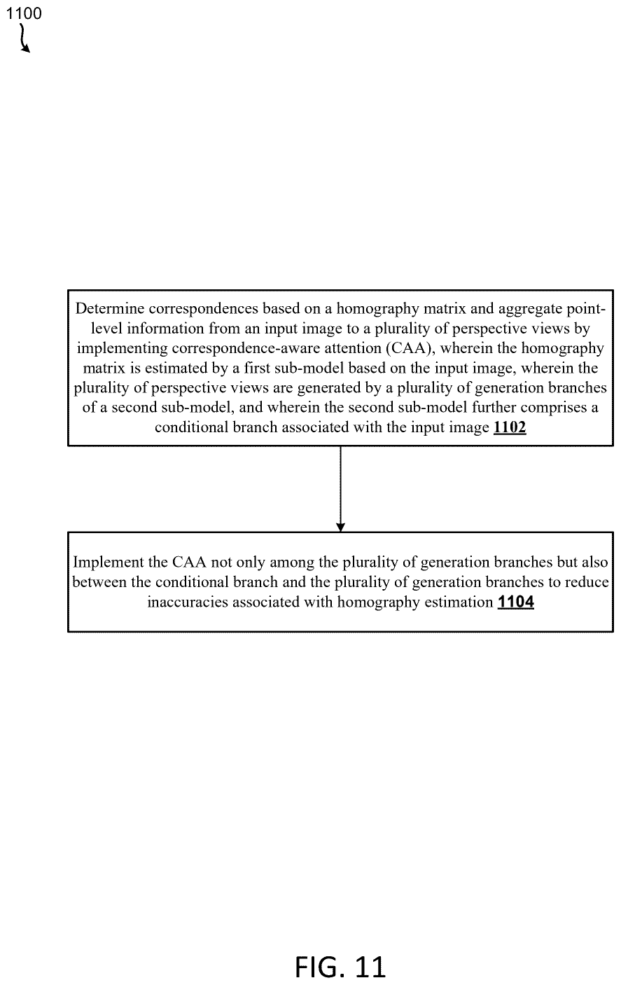

FIG. 11 shows an example process 1100 for generating a panorama based on an input image using a machine learning model in accordance with the present disclosure. Although depicted as a sequence of operations in FIG. 11, those of ordinary skill in the art will appreciate that various embodiments may add, remove, reorder, or modify the depicted operations.

A machine learning model (e.g., the machine learning model 103) can include a first sub-model (e.g., the first sub-model 104) and a second sub-model (e.g., the second sub-model 106). The second sub-model can include a plurality of generation branches. The plurality of generation branches can be associated with a plurality of perspective views (e.g., the plurality of perspective views 108a-n). For example, a first generation branch of the plurality of generation branches can be associated with a first perspective view from the plurality of perspective views, a second generation branch of the plurality of generation branches can be associated with a second perspective view from the plurality of perspective views, and so on. One of the generation branches from the plurality of generation branches can correspond to a perspective view with an absolute rotation angle of zero. The second sub-model can further include a conditional branch associated with the input image.

At 1102, point-level correspondences can be determined based on a homography matrix and point-level information from an input image can be aggregated to a plurality of perspective views by implementing correspondence-aware attention (CAA). The point-level correspondences between the input view and each perspective view enable to enforce geometry consistency among the plurality of perspective views. A first sub-model (e.g., the first sub-model 104) can estimate the homography matrix from an input image (e.g., image 102) to a predefined canonical view (e.g., a perspective view with an absolute rotation angle of zero). A second sub-model (e.g., the second sub-model 106) may comprises a plurality of generation branches to generate the plurality of perspective views. The second sub-model may further comprise a conditional branch associated with the input image. With the estimated homography matrix from the input view to the predefined canonical view, point-wise information can be aggregated from the input view to all target perspective views through CAA. At 1104, the CAA can be implemented not only among the plurality of generation branches, but also between the conditional branch and the plurality of generation branches. This strategy enables to effectively reduce inaccuracies associated with homography estimation. The second sub-model can generate the plurality of perspective views with geometry consistency. A panorama, such as a 360-degree panoramic image, can be generated based on the plurality of perspective views.

Qualitative and quantitative experimental results demonstrate the robustness and generalization ability of the machine learning model 103 for 360-degree image outpainting in the challenging context of camera-free inputs. To conduct the experiments, the machine learning model 103 was fine-tuned on the real-world Matterport3D dataset, which contains 90 building-scale indoor scenes with 10,912 high-resolution panoramic images. 9820 and 1092 images are split for training and evaluation, respectively, following MVDiffusion. Each room in the dataset provides six distinct non-overlapping perspective images taken from identical camera positions, with each offering a 90-field of view. To reach the goal of learning 360-degree image-to-panorama outpainting from camera-free input, a random warp was applied on each perspective image with a field of view from 60 degrees to 110 degrees and camera rotations of ±15 degrees to create camera-free images.

After random warping, all input images are in 512×512 resolution. In addition to the primary dataset, further evaluation of the machine learning model 103 was conducted on the Structured3D dataset, a photo-realistic compilation of 3,500 indoor scenes encompassing 21,835 rooms, each rendered with panoramic images. Perspective images for each room were also generated from random camera positions and poses. This step aims to rigorously assess the generalization abilities of the machine learning model 103 on out-of-domain data. The same random warp approach that was applied in Matterport3D was also applied in Structured3D. A BLIP-2 captioning model was used to generate per-view text descriptions for both datasets mentioned above.

The machine learning model 103 was fine-tuned from the stable diffusion inpainting model. We retain the weights of VAE image encoder/decoder and the latent denoising U-Net blocks frozen as pre-trained. The MLP block was optimized for homography prediction and the CAA blocks were optimized for multi-view consistency with a learning rate 2×10−4 for 30 epochs.

A series of standard image generation metrics were employed to evaluate visual quality. One such metric is Frechet Inception Distance (FID), which quantifies the distance between real and generated images. Another metric is Inception Score (IS), which offers insight into the diversity and quality of generated images. Another metric is CLIP score, which can measure the alignment between a text description and corresponding images. In addition, the Peak signal-to-noise ratio (PSNR) was used on the corresponding region between the generated and target canonical view 0 degrees to evaluate view estimation error. Mean Absolute Error was also used to assess the accuracy of homography estimation only.

The following baselines were considered for the experiments: MVDiffusion and PanoDiffusion. MVDiffusion is a multi-view text-to-image diffusion model to generate view-consistent 360-degree scenes. For comparison, the machine learning model 103 learns to generate from camera-free input with unknown camera parameters. PanoDiffusion is designed for RGB-D panorama outpainting with different types of masks. A super-resolution model further enhances the outpainting results with higher resolution.

A qualitative comparison between a panorama generated using the baseline MVDiffusion and the techniques described herein (e.g., CamFreeDiff) was performed. Both MVDiffusion and CamFreeDiff were trained on Matterport3D dataset. CamFreeDiff is designed and trained to handle arbitrary camera parameters, while MVDiffusion is not. The results of the qualitative comparison show that CamFreeDiff enables the generation of higher-quality, less warped panoramas than MVDiffusion.

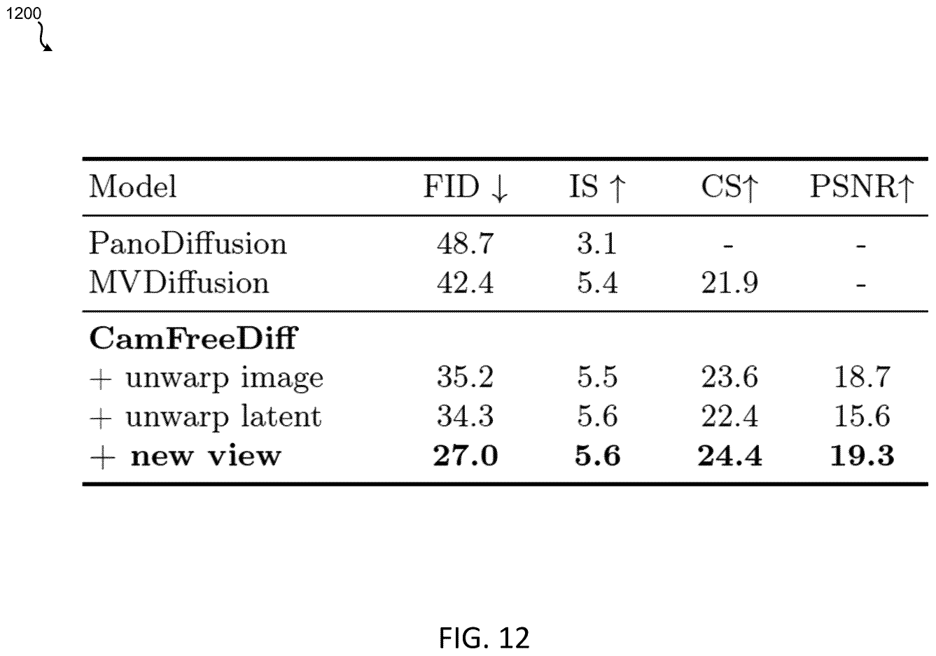

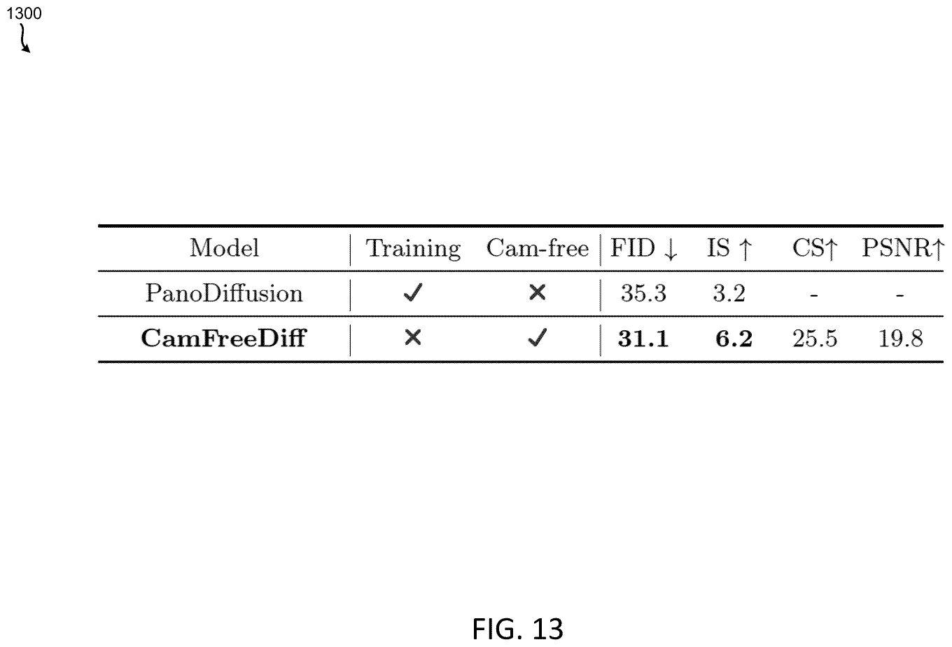

FIG. 12 shows a table 1200 illustrating a quantitative comparison between panorama generation using baseline techniques and different variants of the CamFreeDiff model. As shown in table 1200, CamFreeDiff with Variant 3 (e.g., techniques shown in FIGS. 5-6), treating the input as a new view, achieved the best results in terms of visual quality for panorama generation (FID, IS, CS) and reconstruction quality (PSNR). To demonstrate the generalization ability of CamFreeDiff, CamFreeDiff was also tested on the Structured3D dataset. CamFreeDiff was never trained on or applied with domain transfer techniques from Structured3D. Results shown in the table 1300 of FIG. 13 indicate the strong generalization ability of CamFreeDiff to out-of-domain data, even surpassing PanoDiffusion, which is trained directly on Structured3D but without learning from camera-free input.

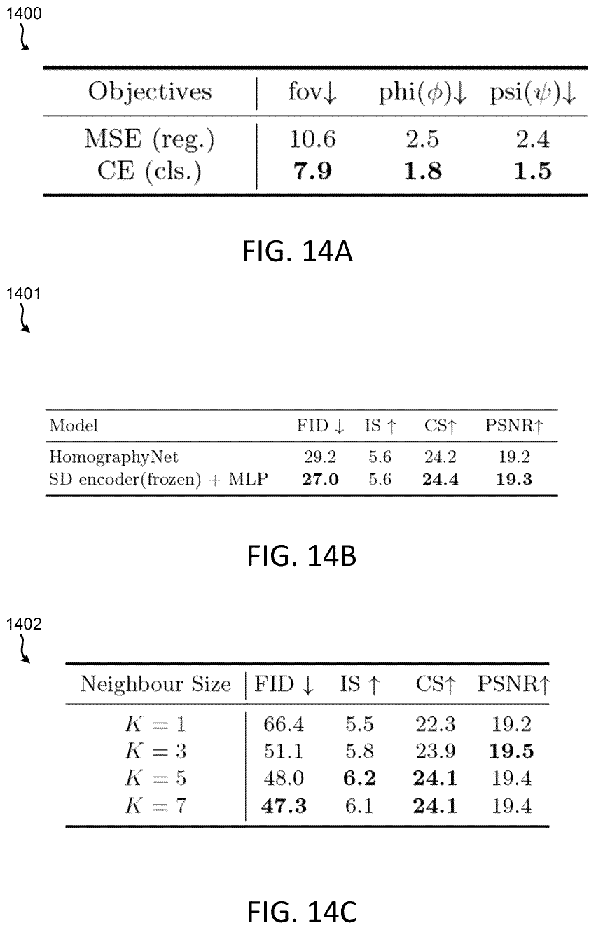

Classification and regression were compared as different types of homography estimators. Cross-entropy loss was used as the objective for the classifier, and mean squared error (MSE) loss was used for the regression model. The classifier gave the best input view estimation results instead of the regression model, as shown in the table 1400 of FIG. 14A. In addition, the architecture design of the homography estimator was ablated. The design of an MLP block built on a frozen stable diffusion image encoder was compared with the HomographyNet, which is designed to predict homography matrix between views. The MLP block built on a frozen stable diffusion image encoder achieve better generation results as shown in the table 1401 of FIG. 14B.

Given correspondences between views, correspondence-aware attention (CAA) aggregates information from source point pₛ neighborhood to target point pₜ, which is the key to yielding consistency between multiple views. The neighborhood in CAA refers to the K×K neighboring points centered at pₛ. The neighborhood size K was ablated for K=1, 3, 5, 7. From results shown in the table 1402 of FIG. 14C, it can be seen that larger neighborhood size generally leads to better multi-view generation quality, but the improvement is limited. Note that larger K results in more computational and time complexity for CAA operation.

In conclusion, the techniques described herein enable the generation of a panorama from a camera-free input image. The camera parameter estimation of the input can be formulated as an estimation of the homography matrix from the input view to a predefined canonical view of the scene. The techniques described herein builds upon the MVDiffusion model for multi-view image generation and incorporates correspondences between the input and target canonical views for coherent and consistent panorama generation. The techniques described herein exhibit a strong robustness to camera-free inputs and have a generalization ability to out-of-domain data.

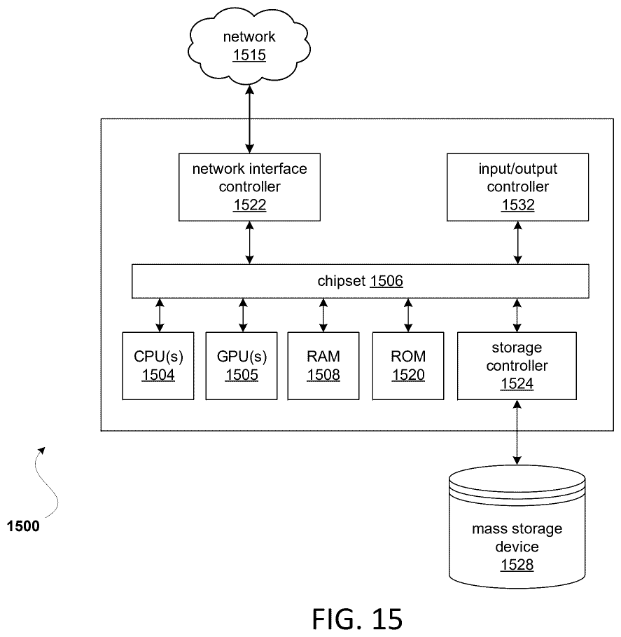

FIG. 15 illustrates a computing device that may be used in various aspects, such as the model(s), components, and/or devices depicted in FIGS. 1-2. With regard to FIGS. 1-2, any or all of the components may each be implemented by one or more instance of a computing device 1500 of FIG. 15. The computer architecture shown in FIG. 15 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1500 may include a baseboard, or “motherboard,” which is a printed circuit board to which a multitude of components or devices may be connected by way of a system bus or other electrical communication paths. One or more central processing units (CPUs) 1504 may operate in conjunction with a chipset 1506. The CPU(s) 1504 may be standard programmable processors that perform arithmetic and logical operations necessary for the operation of the computing device 1500.

The CPU(s) 1504 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1504 may be augmented with or replaced by other processing units, such as GPU(s) 1505. The GPU(s) 1505 may comprise processing units specialized for but not necessarily limited to highly parallel computations, such as graphics and other visualization-related processing.

A chipset 1506 may provide an interface between the CPU(s) 1504 and the remainder of the components and devices on the baseboard. The chipset 1506 may provide an interface to a random-access memory (RAM) 1508 used as the main memory in the computing device 1500. The chipset 1506 may further provide an interface to a computer-readable storage medium, such as a read-only memory (ROM) 1520 or non-volatile RAM (NVRAM) (not shown), for storing basic routines that may help to start up the computing device 1500 and to transfer information between the various components and devices. ROM 1520 or NVRAM may also store other software components necessary for the operation of the computing device 1500 in accordance with the aspects described herein.

The computing device 1500 may operate in a networked environment using logical connections to remote computing nodes and computer systems through local area network (LAN). The chipset 1506 may include functionality for providing network connectivity through a network interface controller (NIC) 1522, such as a gigabit Ethernet adapter. A NIC 1522 may be capable of connecting the computing device 1500 to other computing nodes over a network 1515. It should be appreciated that multiple NICs 1522 may be present in the computing device 1500, connecting the computing device to other types of networks and remote computer systems.

The computing device 1500 may be connected to a mass storage device 1528 that provides non-volatile storage for the computer. The mass storage device 1528 may store system programs, application programs, other program modules, and data, which have been described in greater detail herein. The mass storage device 1528 may be connected to the computing device 1500 through a storage controller 1524 connected to the chipset 1506. The mass storage device 1528 may consist of one or more physical storage units. The mass storage device 1528 may comprise a management component 1510. A storage controller 1524 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1500 may store data on the mass storage device 1528 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1528 is characterized as primary or secondary storage and the like.

For example, the computing device 1500 may store information to the mass storage device 1528 by issuing instructions through a storage controller 1524 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1500 may further read information from the mass storage device 1528 by detecting the physical states or characteristics of one or more particular locations within the physical storage units.

In addition to the mass storage device 1528 described above, the computing device 1500 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1500.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1528 depicted in FIG. 15, may store an operating system utilized to control the operation of the computing device 1500. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1528 may store other system or application programs and data utilized by the computing device 1500.

The mass storage device 1528 or other computer-readable storage media may also be encoded with computer-executable instructions, which, when loaded into the computing device 1500, transforms the computing device from a general-purpose computing system into a special-purpose computer capable of implementing the aspects described herein. These computer-executable instructions transform the computing device 1500 by specifying how the CPU(s) 1504 transition between states, as described above. The computing device 1500 may have access to computer-readable storage media storing computer-executable instructions, which, when executed by the computing device 1500, may perform the methods described herein.

A computing device, such as the computing device 1500 depicted in FIG. 15, may also include an input/output controller 1532 for receiving and processing input from a number of input devices, such as a keyboard, a mouse, a touchpad, a touch screen, an electronic stylus, or other type of input device. Similarly, an input/output controller 1532 may provide output to a display, such as a computer monitor, a flat-panel display, a digital projector, a printer, a plotter, or other type of output device. It will be appreciated that the computing device 1500 may not include all of the components shown in FIG. 15, may include other components that are not explicitly shown in FIG. 15, or may utilize an architecture completely different than that shown in FIG. 15.

As described herein, a computing device may be a physical computing device, such as the computing device 1500 of FIG. 15. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of generating a panorama based on an input image using a machine learning model, comprising:
receiving the input image, wherein camera parameters of the input image are unknown;
estimating a homography matrix from the input image to a predefined canonical view by a first sub-model of the machine learning model, wherein the homography matrix comprises three degrees of freedom (3-DoF), and wherein the homography matrix indicates pixel-level correspondences between the input image and the predefined canonical view;
generating a plurality of perspective views by a second sub-model of the machine learning model based on the homography matrix and a text description of an environment associated with the input image, wherein the second sub-model of the machine learning model is configured to generate new content for extended areas while preserving existing image content; and
generating the panorama based on the plurality of perspective views.

2. The method of claim 1, wherein the 3-DoF of the homography matrix comprise a camera field of view, a camera rotation around an x-axis, and a camera rotation around a z-axis.

3. The method of claim 1, wherein the predefined canonical view corresponds to a perspective view with an absolute rotation angle of zero.

4. The method of claim 1, further comprising:
rectifying the input image based on the homography matrix;
encoding the rectified input image into a latent space; and
providing a representation of the rectified input image to the second sub-model.

5. The method of claim 1, further comprising:
encoding the input image into a latent space;
rectifying a representation of the input image in the latent space based on the homography matrix; and
providing the rectified representation to the second sub-model.

6. The method of claim 1, further comprising:
determining point-level correspondences based on the homography matrix; and
providing the point-level correspondences to the second sub-model, wherein the second sub-model comprises a plurality of generation branches associated with the plurality of perspective views, and wherein the second sub-model further comprises a conditional branch associated with the input image.

7. The method of claim 6, further comprising:
aggregating point-level information from the input image to the plurality of perspective views by implementing correspondence-aware attention (CAA) to enforce geometry consistency.

8. The method of claim 7, further comprising:
implementing the CAA not only among the plurality of generation branches but also between the conditional branch and the plurality of generation branches to reduce inaccuracies associated with homography estimation.

9. The method of claim 6, wherein the second sub-model comprises a generation branch corresponding to a perspective view with an absolute rotation angle of zero.

10. The method of claim 1, wherein the machine learning model is configured to generate a 360-degree panorama based on a single input image with unknown camera parameters.

11. A system of generating a panorama based on an input image using a machine learning model, comprising:
at least one processor; and
at least one memory communicatively coupled to the at least one processor and comprising computer-readable instructions that upon execution by the at least one processor cause the at least one processor to perform operations comprising:
receiving the input image, wherein camera parameters of the input image are unknown;
estimating a homography matrix from the input image to a predefined canonical view by a first sub-model of the machine learning model, wherein the homography matrix comprises three degrees of freedom (3-DoF), and wherein the homography matrix indicates pixel-level correspondences between the input image and the predefined canonical view;
generating a plurality of perspective views by a second sub-model of the machine learning model based on the homography matrix and a text description of an environment associated with the input image, wherein the second sub-model of the machine learning model is configured to generate new content for extended areas while preserving existing image content; and
generating the panorama based on the plurality of perspective views.

12. The system of claim 11, wherein the 3-DoF of the homography matrix comprise a camera field of view, a camera rotation around an x-axis, and a camera rotation around a z-axis, and wherein the predefined canonical view corresponds to a perspective view with an absolute rotation angle of zero.

13. The system of claim 11, the operations further comprising:
rectifying the input image based on the homography matrix;
encoding the rectified input image into a latent space; and
providing a representation of the rectified input image to the second sub-model.

14. The system of claim 11, the operations further comprising:
encoding the input image into a latent space;
rectifying a representation of the input image in the latent space based on the homography matrix; and
providing the rectified representation to the second sub-model.

15. The system of claim 11, the operations further comprising:
determining point-level correspondences based on the homography matrix; and
providing the point-level correspondences to the second sub-model, wherein the second sub-model comprises a plurality of generation branches associated with the plurality of perspective views, and wherein the second sub-model further comprises a conditional branch associated with the input image.

16. The system of claim 15, the operations further comprising:
aggregating point-level information from the input image to the plurality of perspective views by implementing correspondence-aware attention (CAA) to enforce geometry consistency; and
implementing the CAA not only among the plurality of generation branches but also between the conditional branch and the plurality of generation branches to reduce inaccuracies associated with homography estimation.

17. A non-transitory computer-readable storage medium, storing computer-readable instructions that upon execution by a processor cause the processor to implement operations comprising:
receiving the input image, wherein camera parameters of the input image are unknown;
estimating a homography matrix from the input image to a predefined canonical view by a first sub-model of the machine learning model, wherein the homography matrix comprises three degrees of freedom (3-DoF), and wherein the homography matrix indicates pixel-level correspondences between the input image and the predefined canonical view;
generating a plurality of perspective views by a second sub-model of the machine learning model based on the homography matrix and a text description of an environment associated with the input image, wherein the second sub-model of the machine learning model is configured to generate new content for extended areas while preserving existing image content; and
generating the panorama based on the plurality of perspective views.

18. The non-transitory computer-readable storage medium of claim 17, the operations further comprising:
determining point-level correspondences based on the homography matrix; and
providing the point-level correspondences to the second sub-model, wherein the second sub-model comprises a plurality of generation branches associated with the plurality of perspective views, and wherein the second sub-model further comprises a conditional branch associated with the input image.

19. The non-transitory computer-readable storage medium of claim 18, the operations further comprising:
aggregating point-level information from the input image to the plurality of perspective views by implementing correspondence-aware attention (CAA) to enforce geometry consistency; and
implementing the CAA not only among the plurality of generation branches but also between the conditional branch and the plurality of generation branches to reduce inaccuracies associated with homography estimation.

20. The non-transitory computer-readable storage medium of claim 17, wherein the machine learning model is configured to generate a 360-degree panorama based on a single input image with unknown camera parameters.
